(19) United States
(12) Patent Application Publication
(10) Pub. No.: US 2004/0137885 A1
(43) Pub. Date: Jul. 15, 2004

(54) Method of coupling user equipment information specific to a multicast/broadcast service with a multicast/broadcast service context of a controlling network entity

(76) Inventors: Sinikka Sarkkinen, Kangasala (FI); Jari Isokangas, Tampere (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/694,058

(22) Filed: Oct. 28, 2003

Related U.S. Application Data
(60) Provisional application No. 60/424,704, filed on Nov. 8, 2002.

(51) Int. Cl. G01S 5/02; G01S 5/04; H04M 11/10

(52) U.S. Cl. 455/414.1; 342/428; 342/445

(57) ABSTRACT

A user equipment related multicast/multicast/broadcast multimedia service information present in a serving radio network controller can be coupled with the multicast/broadcast multimedia service controlling radio network controller service context in the corresponding controlling radio network controller over the interface between the radio network controller entities.

### CROSS REFERENCE TO RELATED APPLICATION

This application claims the benefit of the filing date of Provisional Patent Application Serial No. 60/424,704, entitled “Method of Coupling User Equipment Information Specific to a Broadcast Server with a Broadcast Service Context of a Controlling Network Entity,” filed Nov. 8, 2002 which application is incorporated herein by reference in its entirety.

### BACKGROUND OF THE INVENTION

1. Field of the Invention

The present invention relates to a method and corresponding system of coupling user equipment information specific to a multicast/broadcast service with a multicast/broadcast service context of a controlling device, wherein a multicast/broadcast service is provided within a communication network comprising a core network and a radio access network, the core network comprising at least one serving device, and the radio access network comprising a plurality of user equipment, at least one serving device, and controlling devices.

2. Related Background Art

Recently, the standardization of the multicast/broadcast multimedia service (MBMS) according to the 3^{rd} Generation Partnership Project (3GPP) has been started in radio access network (RAN) working groups. Thus, the procedures to support the multicast/broadcast multimedia service (MBMS) initialization are started. In order to get common understanding of the principles to define the multicast/broadcast multimedia service (MBMS) architecture and the procedures, some basic assumptions have been made already now. These assumptions are disclosed in the early version V1.1.0 of May 2002 of document “3GGP TS 25.346”, and shall be summarized as follows:

Firstly, a controlling radio network controller (CRNC) which is a RNC controlling a cell maintains one context per established multicast/broadcast multimedia service (MBMS). This is true for each CRNC within a MBMS serving area. That is, each controlling radio network controller (CRNC) multicast/broadcast multimedia service (MBMS) context (CRNC MBMS context) is associated with a MBMS service ID. Further, the CRNC MBMS context contains a list of user equipment (UE) in connected mode which are present in each cell of the CRNC and which have activated (i.e. has performed the joining) a MBMS service. In addition, the CRNC MBMS context is established when the radio access bearer (RAB) for the MBMS is established between the radio network controller (RNC) and the serving GPRS support node (SGSN; General Packet Radio Network) for a specific multicast/broadcast multimedia service (MBMS).

Secondly, there shall be one flow over the lu-interface (the interface between a radio network controller and the core network) per radio network controller (RNC) per established multicast/broadcast multimedia service (MBMS). Thus, each user equipment (UE) in connected mode with an activated multicast/broadcast multimedia service (MBMS) has its user equipment (UE) context bind to the radio access bearer (RAB) for this multicast/broadcast multimedia service (MBMS).

Thirdly, it shall be possible to map the flow over the lu-interface on a point-to-multipoint (p-t-m) connection.

### SUMMARY OF THE INVENTION

The present inventors have recognized that, in order to fulfill the working assumptions above, the user equipment (UE) specific information in a serving radio network controller (SRNC) and the service specific information in a controlling radio network controller (CRNC) have to be combined at least before the activation of the MBMS service over the air interface.

Therefore, the present invention provides a method as well as a corresponding system and corresponding communication devices for performing this coupling, when the controlling radio network controller (CRNC) and the serving radio network controller (SRNC) are different radio network controller (RNC).

The present invention is a method of coupling user equipment information specific to a multicast/broadcast service with a multicast/broadcast service context of a controlling device, wherein a multicast/broadcast service is provided within a communication network comprising a core network and a radio access network, the core network comprising at least one serving device, and the radio access network comprising a plurality of user equipment, at least one serving device, and controlling devices, the method comprising: establishing a multicast/broadcast service context of a controlling device by a serving device of the core network; establishing a user equipment specific multicast/broadcast service context by the serving device of the core network, wherein this establishing procedure is capable of being effected upon a different time as the controlling device multicast/broadcast service context establishing procedure; determining a respective location of user equipment which desire to join the multicast/broadcast service by a serving device of the radio access network by checking a respective list received from the serving device of the core network; sending a user equipment active list by the serving device of the radio access network informing the controlling device about the number of joined user equipment and the multicast/broadcast service in question, wherein the active list includes, if applicable, also respectively joined user equipment within a cell controlled by another controlling device; selecting a channel type by the controlling device for the connection of the multicast/broadcast service to the respectively joined user equipment; informing the serving device of the radio access network about the selection; and informing the respectively joined user equipment by the serving device of the radio access network about the multicast/broadcast service.

As an advantageous modification of the method according to the present invention, the selecting step and the selection informing step are not performed, and the multicast/broadcast informing step includes an indication about the unsuccessful coupling of the respectively joined user equipment to the multicast/broadcast service, if the multicast/broadcast service context of a controlling device is rejected.

The present invention is also a serving device of a core network, comprising: means for establishing a multicast/broadcast service context of a controlling device of a radio access network; means for establishing a user equipment specific multicast/broadcast service context at a different time; and means for sending a list of respective locations of user equipment which desire to join the multicast/broadcast service.

Further, the present invention is also a serving device of a radio access network, comprising: means for determining a respective location of user equipment which desire to join a multicast/broadcast service by checking a respective list received from a serving device of a core network; means for sending a user equipment active list informing a controlling device of the radio access network about the number of joined user equipment and the multicast/broadcast service in question, wherein the active list includes, if applicable, also respectively joined user equipment within a cell controlled by another controlling device of the radio access network; and means for informing the respectively joined user equipment about the multicast/broadcast service.

Still further, the present invention is also a controlling device of a radio access network, comprising: means for selecting a channel type for the connection of a multicast/broadcast service to respectively joined user equipment; means for informing a serving device of the radio access network about the selection; and means for informing the serving device of the radio access network about an unsuccessful coupling of the respectively joined user equipment to the multicast/broadcast service.

Moreover, the present invention is also a system for coupling user equipment information specific to a multicast/broadcast service with a multicast/broadcast service context of a controlling device, the system providing a multicast/broadcast service and comprising a core network and a radio access network, the system comprising: at least one serving device according to the present invention; at least one serving device according to the present invention; controlling devices according to the present invention; and a plurality of user equipment.

According to the present invention, the user equipment (UE) related multicast/broadcast multimedia service (MBMS) information present in a serving radio network controller (SRNC) can be coupled with the multicast/broadcast multimedia service (MBMS) controlling radio network controller (CRNC) service context in the corresponding controlling radio network controller (CRNC) over the lur-interface (being the interface between radio network controller entities). The multicast/broadcast multimedia service (MBMS) controlling radio network controller (CRNC) service context (MBMS CRNC service context) is the context, which is generated for the multicast/broadcast multimedia service (MBMS) by the request of the serving GPRS support node (SGSN). The establishment of the MBMS CRNC service context corresponds to the establishment of the radio access bearer (RAB) for the normal speech and packet calls. The main difference in this case is that when radio access bearer (RAB) is/are assigned only for one user equipment (UE), the MBMS CRNC service context is assigned for the service and not for any specific user equipment (UE). The number of MBMS CRNC service context in a controlling radio network controller (CRNC) is one per service session.

According to the present invention, the following advantages are obtained.

The respective establishment of the multicast/broadcast multimedia service (MBMS) controlling radio network controller (CRNC) service context and of the user equipment (UE) specific multicast/broadcast multimedia service (MBMS) context in the serving radio network controller (SRNC) do not have to happen simultaneously.

Only those serving radio network controller (SRNC) are sending an indication to the controlling radio network controller (CRNC) which have multicast/broadcast multimedia service (MBMS) authorized user equipment (UE) for the service in question. Other serving radio network controller (SRNC) are silent.

According to the present invention, the controlling radio network controller (CRNC) can inform the serving radio network controller (SRNC) about the rejection of the coupling (e.g. when no multicast/broadcast multimedia service (MBMS) controlling radio network controller (CRNC) service context is established in the corresponding controlling radio network controller (CRNC)).

Moreover, the present invention allows for the transmission of multicast/broadcast multimedia service (MBMS) related control information between only those serving radio network controller(s) (SRNC) and controlling radio network controller(s) (CRNC) which have indicated multicast/broadcast multimedia service (MBMS) authorized user equipment (UE).

The present invention is particularly advantageous in cases

when the user equipment (UE) has to be in a radio resource control (RRC) connected mode in order to get the multicast/broadcast multimedia service (MBMS);

when the user equipment (UE) is in a UTRAN registration area (URA)—paging channel (PCH) state (UMTS Terrestrial Radio Access Network—Universal Mobile Telecommunication System) and the URA covers cells under at least two controlling radio network controller (CRNC); and

when only the Anchor Radio Network Controller concept is supported.

By the provision of the present invention, the coupling of the user equipment (UE) related multicast/broadcast multimedia service (MBMS) information with the multicast/broadcast multimedia service (MBMS) controlling radio network controller (CRNC) service context is possible and thus allows for the controlling radio network controller (CRNC) to make a channel type selection between “point-to-point” (p-t-p) and “point-to-multipoint” (p-t-m). That is, the controlling radio network controller (CRNC) defines whether the multicast/broadcast multimedia service data is transmitted over the air interface by using either the point-to-point (p-t-p) or point-to-multipoint (p-t-m) connections. The point-to-point connection is selected when it is more optimal from radio resource point of view to establish a point-to-point connection to each user equipment (UE) in the cell than to use point-to-multipoint connection, i.e. the number of user equipment (UE) is under the selection threshold.

By the same token, the coupling is performed when the multicast/broadcast multimedia service (MBMS) controlling radio network controller (CRNC) service context is established in the corresponding controlling radio network controller (CRNC), and when the indication about the valid multicast/broadcast multimedia service (MBMS) is included into user equipment (UE) related radio resource control (RRC) active set. Here, “RRC active set list” is the list of radio access bearer (RAB)/radio bearer (RB), which has been established for the user equipment (UE) and which has not been released either by the command of the serving radio network controller (SRNC) or of the serving GPRS support node (SGSN).

Hence, by providing the coupling procedure according to the present invention, the controlling radio network controller (CRNC) is prevented from making wrong decisions regarding the used channel type such as the following: A point-to-point (p-t-p) connection may be selected even if there are enough user equipment (UE) in the cell to establish the point-to-multipoint connection, i.e. the controlling radio network controller (CRNC) does not act as a serving radio network controller (SRNC) for all user equipment (UE) in the cell. Albeit the decision of using a point-to-point connection is correct, no point-to-point related configuration parameters might be submitted to the user equipment (UE) served by another serving radio network controller (SRNC).

### BRIEF DESCRIPTION OF THE DRAWINGS

Further details and advantages of the present invention will become apparent from the following detailed description of the preferred embodiments which are to be taken in conjunction with the appended drawings, in which:

FIG. 1 shows a preferred embodiment of the present invention; and

FIG. 2 shows an advantageous modification of the preferred embodiment according to the present invention.

### DETAILED DESCRIPTION OF THE PREFERRED EMBODIMENTS

According to the present invention, the multicast/broadcast multimedia service (MBMS) user equipment (UE) information in the serving radio network controller (SRNC) is coupled with the multicast/broadcast multimedia service (MBMS) controlling radio network controller (CRNC) service context over the lur-interface, when both the user equipment (UE) specific context in the serving radio network controller (SRNC) and the multicast/broadcast multimedia service (MBMS) controlling radio network controller (CRNC) service context in the controlling radio network controller (CRNC) are established.

In addition, the multicast/broadcast multimedia service (MBMS) controlling radio network controller (CRNC) service context establishment is kept as a separate procedure with respect to the establishment of the user equipment (UE) specific multicast/broadcast multimedia service (MBMS) context. Therefore, since they are separated, they can be initiated upon different time. The initiator is in both cases the serving GPRS support node (SGSN). When the contexts are established separately, it is the responsibility of the serving radio network controller (SRNC) to check the list of the “joined user equipment (UE)” which is received from the serving GPRS support node (SGSN), and to find out the location of the user equipment (UE) in the network. If such user equipment (UE) are found which are under a cell controlled by another controlling radio network controller (CRNC), the serving radio network controller (SRNC) is responsible for informing the controlling radio network controller (CRNC) about the user equipment (UE) in connected mode. This is performed by sending the user equipment (UE) active set over the lur-interface, wherein the number of joined user equipment (UE) and the MBSM service in question is indicated. Based on this message, the controlling radio network controller (CRNC) can also take into account these user equipment (UE) when the selection of the channel type is made. As a response message, the controlling radio network controller (CRNC) can give information about, for example, the selected parameters and the selected channel type to the serving radio network controller (SRNC), in order to help the serving radio network controller (SRNC) in informing the user equipment (UE) about the multicast/broadcast multimedia service (MBMS).

When the responsibility of informing the “joined” user equipment (UE) in connected mode is given to the serving radio network controller (SRNC), the number of the required signaling messages can be decreased, because only those serving radio network controller (SRNC) are informing by the controlling radio network controller (CRNC), which actually serve the user equipment (UE) within the cell of the controlling radio network controller (CRNC). The present invention also allows for the controlling radio network controller (CRNC) to send the multicast/broadcast multimedia service (MBMS) related control information to the serving radio network controller (SRNC) inside the response message as soon as the channel selection is performed and configuration parameters are selected. In addition, the present invention also allows for the controlling radio network controller (CRNC) to inform the serving radio network controller (SRNC) in a case, when the controlling radio network controller (CRNC) is not aware of the multicast/broadcast multimedia service (MBMS) indicated by the serving radio network controller (SRNC). Therefore, the same procedure can be used for a different purpose by including the correct fields into the used Radio Network Subsystem Application Part (RNSAP) multicast/broadcast multimedia service (MBMS) related messages.

A preferred embodiment of the present invention is described hereinafter by reference to the accompanying drawings.

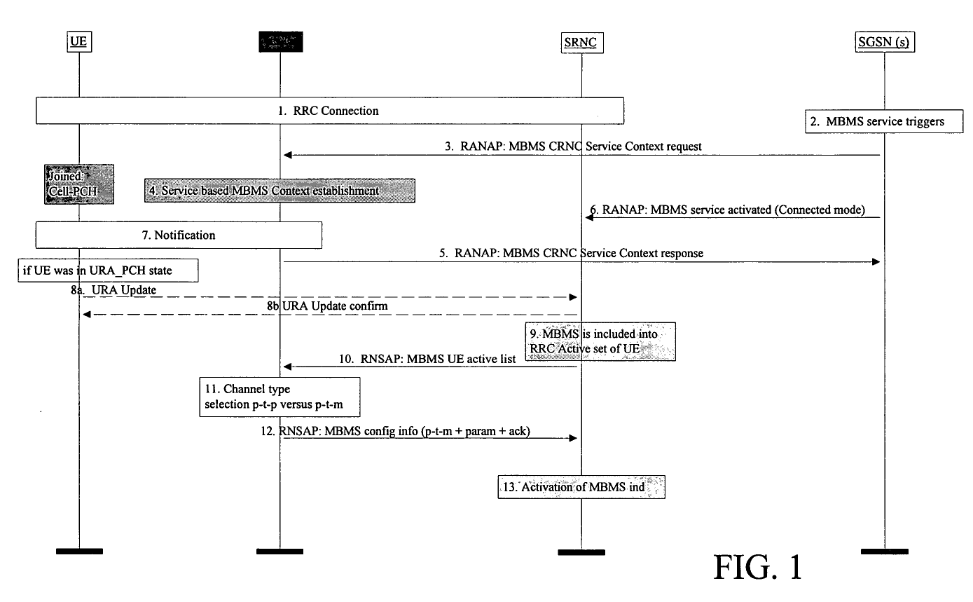

By making reference to FIG. 1, described hereinafter are the steps of a preferred embodiment of the present invention.

At the beginning, the user equipment UE is in a radio resource control (RRC) connected state, that is the user equipment UE is either in the cell paging channel (Cell_PCH) state or in the UTRAN registration area paging channel (URA_PCH) state (step 1.). Then, a serving GPRS support node SGSN is triggered to start the MBMS service activation. As a part of this activation process, the serving GPRS support node SGSN requests the radio resources for the MBMS service from the controlling radio network controller CRNC (step 2.). Next, the serving GPRS support node SGSN sends a MBMS CRNC service context request to those controlling radio network controller CRNC, which, for example, belong to the selected multicast service area (step 3.). The used protocol on the lu-interface (that is the interface between the radio network controller and the core network) is radio access network application part (RANAP).

The controlling radio network controller CRNC, after having received the MBMS CRNC service context request, both establishes the MBMS CRNC service context MCSC for the service and reserves the required radio resources (step 4.). After the successful establishment of the context, the controlling radio network controller CRNC sends a MBMS CRNC service context response to the serving GPRS support node SGSN in order to terminate the procedure at the core network (CN) side (step 5.). If the controlling radio network controller CRNC decides not to establish the MBMS CRNC service context (MCMC), the response contains an un-acknowledgment in order to inform the unsuccessful establishment of the context in it.

When the serving GPRS support node SGSN discovers the initialization of the MBMS service activation, it checks from its databases which user equipment UE already have joined the MBMS, that is they have authenticated themselves to receive the MBMS service in question, and which are in packet mobility management (PMM) connected state, that is which have the dedicated lu-signaling connection over the lu-interface. Based on this information, the serving GPRS support node SGSN decides to which serving radio network controller SRNC it sends the MBMS service activation message. If the message is sent by using the dedicated lu-signaling connection, no user equipment UE specific identification is required. However, if the message is sent through a common (MBMS related) signaling channel, the identification of the joined user equipment UE must be included (altogether step 6.).

After establishment of the MBMS CRNC service context (MCSC), the controlling radio network controller CRNS may start the notification procedure on the air interface in order to inform about the forthcoming MBMS service (step 7.).

If the user equipment UE is in the UTRAN registration area (URA) paging channel (URA_PCH) state, after receipt of the notification, the user equipment UE sends a URA update to the serving radio network controller SRNC in order to inform its location on the cell level. The update is performed by using the currently known “URA update” (step 8a.) and “URA update confirm” (step 8b.) messages. Upon receipt of the MBMS service activation message, the serving radio network controller SRNC identifies the user equipment UE in question and includes the MBMS service into the radio resource control active set (RRC active set) of these user equipment UE (step 9.).

Next, the serving radio network controller SRNC waits a predetermined time and then generates the MBMS UE active set, wherein the serving radio network controller SRNC indicates, for example, the number of user equipment UE (controlled by this SRNC), who are interested to get the MBMS service. The number of the user equipment UE can be gathered by comparing the location information of the user equipment UE with the user equipment UE identities received from the MBMS service activation message. The MBMS UE active set message is sent by using the radio access network subsystem application part (RNSAP) protocol (step 10.).

Now, after having received the MBMS UE active set, the controlling radio network controller CRNC performs the channel type selection between point-to-point and point-to-multipoint (step 11.). After that and having selected the required configuration parameters for the MBMS service, the controlling radio network controller CRNC sends the MBMS configuration information (MBMS config info) to the serving radio network controller SRNC, wherein it is informed e.g. about the existence of the MBMS service context, about the result of the channel type selection, and about the parameters for the MBMS service (step 12.). It is to be noted that if the controlling radio network controller CRNC does not have the context for the service, the MBMS config info can be used to inform the serving radio network controller SRNC about the missing context. The message is sent by using the radio network subsystem application part (RNSAP) protocol.

Thus, after receiving the MBMS config info, the serving radio network control SRNC actives the included indications into the RRC active set (see step 9.). After the activation of the MBMS service in the RRC active set, the service will be considered as one service among the other user equipment UE specific services (step 13.).

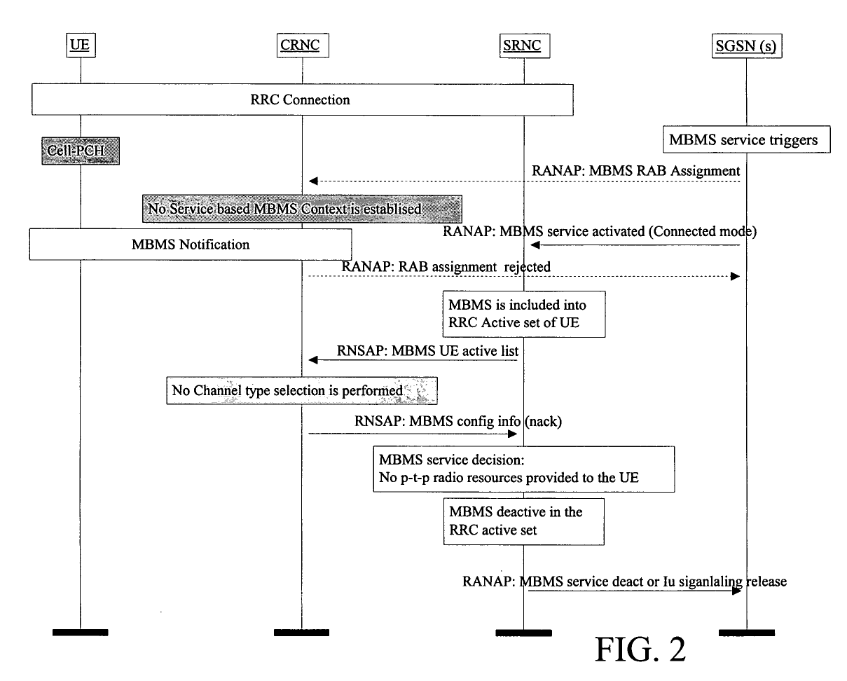

FIG. 2 presents the case when no MBMS CRNC service context is established in a controlling radio network controller CRNC, and therefore the controlling radio network controller CRNC rejects to couple the user equipment UE specific MBMS information to the context in CRNC. The depicted blocks and arrows correspond to respective ones shown in FIG. 1, where applicable, and actions corresponding to the above described steps are illustrated.

Thus, in order to also delete the context from the RRC active set, the serving radio network controller SRNC sends at the end a signaling message (the last message in FIG. 2), wherein the unsuccessful coupling of the user equipment UE to the forthcoming MBMS service is indicated. This message is sent by using the radio access network application part (RANAP) protocol.

While it has been explained above what is presently considered to be preferred embodiments of the present invention, it is apparent to those skilled in the art that various modifications and equivalents may be made without deviating from the spirit and scope of the present invention as defined in the appended claims.

1. A method of coupling user equipment information specific to a multicast/broadcast service with a multicast/broadcast service context of a controlling device, wherein a multicast/broadcast service is provided within a communication network comprising a core network and a radio access network, the core network comprising at least one serving device, and the radio access network comprising a plurality of user equipment, at least one serving device, and controlling devices, the method comprising:
establishing a multicast/broadcast service context of a controlling device by a serving device of the core network;
establishing a user equipment specific multicast/broadcast service context by the serving device of the core network, wherein this establishing procedure is capable of being effected upon a different time as the controlling device multicast/broadcast service context establishing procedure;
determining a respective location of user equipment which desire to join the broadcast service by a serving device of the radio access network by checking a respective list received from the serving device of the core network;
sending a user equipment active list by the serving device of the radio access network informing the controlling device about the number of joined user equipment and the multicast/broadcast service in question, wherein the active list includes, if applicable, also respectively joined user equipment within a cell controlled by another controlling device;
selecting a channel type by the controlling device for the connection of the multicast/broadcast service to the respectively joined user equipment;
informing the serving device of the radio access network about the selection;
activating the multicast/broadcast service context in the serving device of the radio access network as an accepted service for the user equipment after receipt of successful coupling information from the controlling device; and
informing the respectively joined user equipment by the serving device of the radio access network about the multicast/broadcast service.

2. The method according to claim 1, wherein when the multicast/broadcast service context is activated in the serving device of the radio access network, the activated multicast/broadcast context is taken into account when radio resource controlling states for the user equipment are updated.

3. The method according to claim 1, wherein the multicast/broadcast service context of the controlling device is rejected, and the selecting step and the selection informing step are not performed, and the multicast/broadcast informing step includes an indication about the unsuccessful coupling of the respectively joined user equipment to the multicast/broadcast service.

4. The method according to claim 3, wherein rejection is informed to the serving device, so that the serving device is allowed to decide whether the multicast/broadcast service informed in the multicast/broadcast service context of the controlling device is served to the user equipment by using user equipment specific dedicated channels.

5. The method according to claim 4, wherein if the decision about using user equipment specific dedicated channels for multicast/broadcast service informed in the service context is rejected or the decision to use the user equipment specific dedicated channels is negative, the multicast/broadcast service context is not activated and the serving device of the radio access network does not take this activated multicast/broadcast context into account when Radio Resource Controlling states for the user equipment are defined.

6. The method according to claim 5, wherein if the use of the user equipment specific dedicated channels for the multicast/broadcast service is rejected, a removal of the multicast/broadcast service context from the serving device is started by informing an unsuccessful context support to the serving device of the core network.

7. A serving device of a core network, comprising:
means for establishing a multicast/broadcast service context of a controlling device of a radio access network;
means for establishing a user equipment specific multicast/broadcast service context at a different time;
means for sending a list of respective locations of user equipment which desire to join the multicast/broadcast service; and
means for the handling of an unsuccessful context information from the serving device.

8. A serving device of a radio access network, comprising:
means for determining a respective location of user equipment which desire to join a multicast/broadcast service by checking a respective list received from a serving device of a core network;
means for sending a user equipment active list informing a controlling device of the radio access network about the respective number of user equipment which join respective multicast/broadcast services in question, wherein the active list includes, if applicable, also respectively joined user equipment within a cell controlled by another controlling device of the radio access network;
means for activating the multicast/broadcast service in the serving device as an accepted service by the controlling device after receipt of information about the successful coupling;
means for informing the respectively joined user equipment about the multicast/broadcast service;
means for deciding whether the multicast/broadcast service can be served to user equipment by using the user equipment dedicated specific channels after an unsuccessful coupling in the controlling device; and
means for using received information about successful coupling when the Radio Resource Controlling (RRC) state for the user device is updating.

9. A controlling device of a radio access network, comprising:
means for selecting a channel type for the connection of a multicast/broadcast service to respectively joined user equipment;
means for informing a serving device of the radio access network about the selection; and
means for informing the serving device of the radio access network about an unsuccessful coupling of the respectively joined user equipment to the multicast/broadcast service.

10. A system for coupling user equipment information specific to a multicast/broadcast service with a multicast/broadcast service context of a controlling device, the system providing a multicast/broadcast service and comprising a core network and a radio access network, the system comprising:
at least one serving device of the core network according to claim 3;
at least one serving device of the radio access network according to claim 4;
controlling devices of the radio access network according to claim 5; and
a plurality of user equipment.
